(19) United States
(12) Patent Application Publication
(10) Pub. No.: US 2014/0232346 A1
(43) Pub. Date: Aug. 21, 2014

(54) ACTIVE CELL AND MODULE BALANCING FOR BATTERIES OR OTHER POWER SUPPLIES

(71) Applicant: National Semiconductor Corporation, Santa Clara, CA (US)

(72) Inventors: Jianhui Zhang, San Jose, CA (US); Ali Djabbari, Saratoga, CA (US); Qinggui Liu, Sunnyvale, CA (US); Ahmad Bahai, Lafayette, CA (US)

(73) Assignee: National Semiconductor Corporation, Santa Clara, CA (US)

(21) Appl. No.: 14/183,233

(22) Filed: Feb. 18, 2014

Related U.S. Application Data
(63) Continuation of application No. 12/882,781, filed on Sep. 15, 2010.
(60) Provisional application No. 61/243,072, filed on Sep. 16, 2009.

(51) Int. Cl. H02J 7/00

(52) U.S. Cl. CPC H02J 7/0019
USPC 320/118; 320/121; 320/116

(57) ABSTRACT

A system configured to actively balance power among power cells such as batteries. The system includes a power module of series-coupled power cells, each exhibiting different charge levels during charging and discharging. A power module includes active cell balancing circuitry configured to substantially balance the charges of the power cells at least during charging. In one embodiment, the active cell balancing circuitry includes: (a) current source circuitry configured to supply extra charging current to a selected power cell; and (b) current source control circuitry configured to control the current source circuitry to supply extra charging current to the power cell with the lowest state of charge. In another embodiment, the system includes multiple power modules, each having multiple power cells coupled in series, and each having an active cell balancing circuit configured to substantially balance the charges of the power cells in an associated one of the power modules.

### CROSS-REFERENCE TO RELATED APPLICATION AND PRIORITY CLAIM

This application is a continuation of U.S. patent application Ser. No. 12/882,781, filed Sep. 15, 2010, which claims priority to U.S. Provisional Patent Application No. 61/243,072 filed on Sep. 16, 2009, which are hereby incorporated by reference.

### TECHNICAL FIELD

This disclosure is generally directed to power supply charging and discharging systems. More specifically, this disclosure is directed to active cell and module balancing for batteries or other power supplies.

### BACKGROUND

Modern batteries, such as large lithium ion batteries, often include multiple battery cells connected In series. Unfortunately, the actual output voltage provided by each individual battery cell in a battery may vary slightly. This can cause problems during charging or discharging of the battery cells. In some systems, voltage detection circuitry can be used to determine the output voltage of each battery cell, and a voltage balancing system can be used to compensate for variations in the output voltages of the battery cells.

Consider battery cells connected in series, where each battery cell is ideally designed to provide an output voltage of 3v. Voltage detection circuitry may determine that one of the battery cells actually has an output voltage of 3.9V. A conventional passive voltage balancing system typically includes resistors that dissipate electrical energy from battery cells having excessive output voltages. In this example, the dissipation of electrical energy causes the 3.9V output voltage to drop to the desired level of 3.8V. However, since electrical energy is dissipated using the resistors, this can result in significant energy being lost from the battery cell, which shortens the operational life of the battery.

### BRIEF DESCRIPTION OF DRAWINGS

For a more complete understanding of this disclosure and its features, reference is now made to the following description, taken in conjunction with the accompanying drawings, in which:

FIG. 1 illustrates an example active cell balancing circuit in accordance with this disclosure;

FIG. 2 illustrates another example active cell balancing circuit in accordance with this disclosure;

FIG. 3 illustrates an example active cell balancing circuit incorporating switch driving circuits in accordance with this disclosure;

FIG. 4 illustrates an example algorithm that can be used during active cell balancing according to this disclosure;

FIG. 5 illustrates an example power pack with multiple modules each having multiple power cells according to this disclosure;

FIG. 6 illustrates example safe operating regions of various batteries according to this disclosure;

FIG. 7 illustrates example uneven voltage levels on power cells in modules according to this disclosure;

FIG. 8 illustrates an example active module balancing system in accordance with this disclosure; and

FIG. 9 illustrates an example bi-directional active cell balancing circuit that supports active cell balancing within a module according to this disclosure.

### DETAILED DESCRIPTION

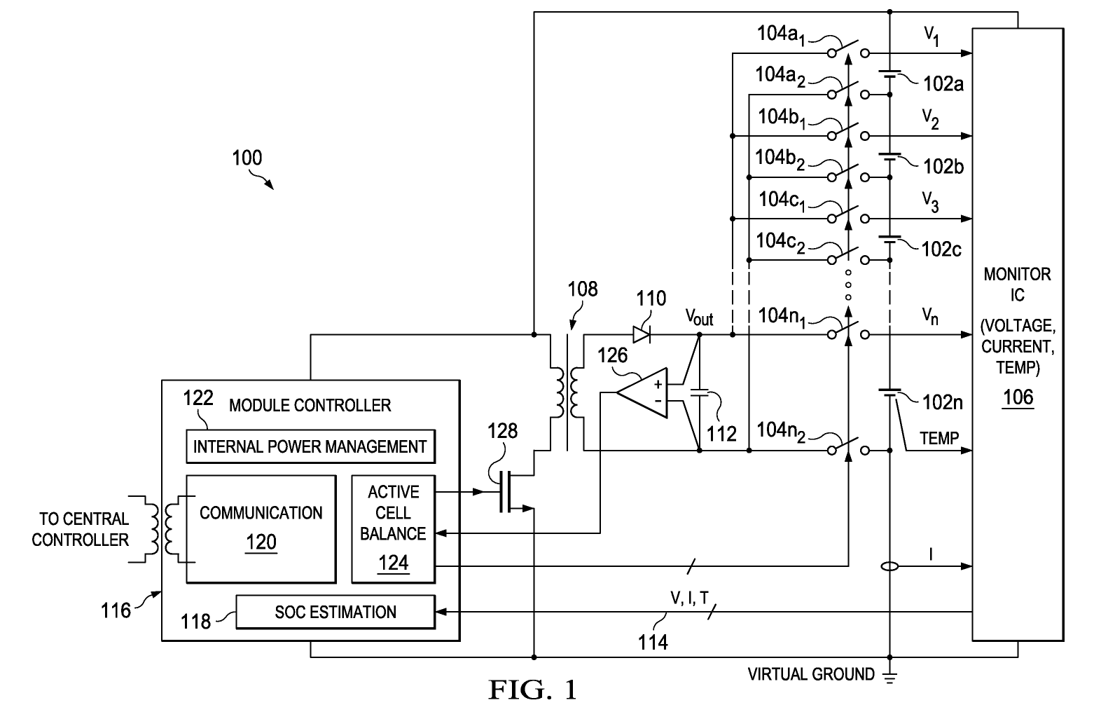

FIG. 1 through 9, described below, and the various embodiments used to describe the principles of the present invention in this patent document are by way of illustration only and should not be construed in any way to limit the scope of the invention. Those skilled in the art will understand that the principles of the present invention may be implemented in any type of suitably arranged device or system.

Active Cell Balancing

In one aspect of this disclosure, various active cell balancing circuits are disclosed that can balance multiple power cells connected in series within a single module, such as multiple battery cells in a single battery. In some embodiments, a monitor receives information related to the power cells, such as voltage, current, and temperature. Using that information, an active balancing circuit can operate a system of switches to connect an electrical source to one or more power cells with lower voltage(s) to charge those power cells to a desired higher voltage. An active balancing circuit can also operate the system of switches to drain power from one or more power cells with excessive voltage(s) to bring the power cells to a desired lower voltage.

FIG. 1 illustrates an example active cell balancing circuit 100 in accordance with this disclosure. In this example, the circuit 100 employs forward-based active cell balancing. The circuit 100 includes or is coupled to multiple power cells 102a-102n connected in series. Each power cell 102a-102n is coupled to two switches 104a1-104a2, 104b1-104b2, 104n1-104n2, respectively. The power cells 102a-102n represent any suitable sources of power within a module, such as battery cells within a battery. The switches 104a1-104n2 represent any suitable switching devices, such as transistors.

A monitor circuit 106 receives information about the power cells 102a-102n, such as information concerning voltage, current, and temperature associated with the power cells 102a-102n. In this example, the information includes voltage values V1-Vn from the power cells 102a-102n, respectively. The information also includes a total current I flowing through the power cells 102a-102n and one or more temperatures TEMP of the power cells 102a-102n.

Note that the number of temperature sensors used and their locations may depend upon the nature of the particular application. A single power cell could be associated with one or multiple temperature sensors, and/or a single temperature sensor could measure the temperature of one or multiple power cells. The monitor circuit 106 represents any suitable structure for monitoring power cells, such as an integrated circuit or “IC.”

As shown in FIG. 1, the switches 104a1-104a2 couple opposite ends of the power cell 102a to opposite ends of a transformer 108. The switches 104b1-104b2 through 104n1-104n2 couple opposite ends of the power cells 102b-102n, respectively, to the opposite ends of the transformer 108. A diode 110 is coupled between one end of the transformer 108 and the switches 104a1, 104b11, 104n1. A capacitor 112 is coupled to the diode 110 and to the other end of the transformer 108.

An output of the monitor circuit 106 is connected via a signal line 114 to a module controller 116. The signal line 114 provides voltage, current, and temperature information or other information from the monitor circuit 106 to the module controller 116. The signal line 114 represents any suitable signal trace or other communication path. The module controller 116 operates to control the charging of the power cells 102a-102n based on that information.

In this example, the module controller 116 includes a state of charge (SOC) estimation module 118, which estimates the state of charge for each of the power cells 102a-102n. A communications module 120 facilitates communication with a central controller, which could support module balancing (described below). The communications could occur over an isolated communication link. The module controller 116 further includes an internal power management module 122, which can control the overall operation of the module controller 116. In addition, the module controller 116 includes an active cell balance module 124. The active cell balance module 124 controls the operation of the switches 104a1-104n₂. A voltage sensor 126 is connected in parallel with the capacitor 112, and the active cell balance module 124 receives voltage information from the voltage sensor 126. The active cell balance module 124 also controls the operation of a transistor 128, which can be opened to interrupt the operation of the transformer 108. The module controller 116 represents any suitable structure for controlling active cell balancing. The voltage sensor 126 represents any suitable structure for sensing voltage. The transistor 128 represents any suitable transistor device.

In one aspect of operation, the monitor circuit 106 may continually, near-continually, or intermittently monitor the voltage, current, and temperature information from the power cells 102a-102n. The monitor circuit 106 can send various information to the module controller 116. If the module controller 116 determines that the first power cell 102a is the weakest cell (has the lowest output voltage), the active cell balance module 124 can cause the switches 104a1-104a2 to close and cause the other switches 104b1-104n2 to open. This causes current from the secondary side of the transformer 108 to flow through the diode 110, the switch 104a1, the power cell 102a, and the switch 104a2 back to the secondary side of the transformer 108. This provides an extra charge to charge up the power cell 102a. The module controller 116 can determine when the power cell 102a has been sufficiently charged (such as when it reaches an average charge of the power cells 102a-102n) and cause the active cell balance module 124 to open the switches 104a1-104a2. This process could be repeated any number of times to charge any of the power cells 102a-102n.

The transformer 108, diode 110, and switches 104a1-104n2 effectively function as controllable current sources coupled to the power cells 102a-102n. These controllable current sources can be used to charge up any of the power cells 102a-102n individually or in groups (as described below). Because of this, the active cell balancing circuit 100 can help to keep the output voltages of the power cells 102a-102n all at or near a desired level. Any other suitable controllable current sources could be used here.

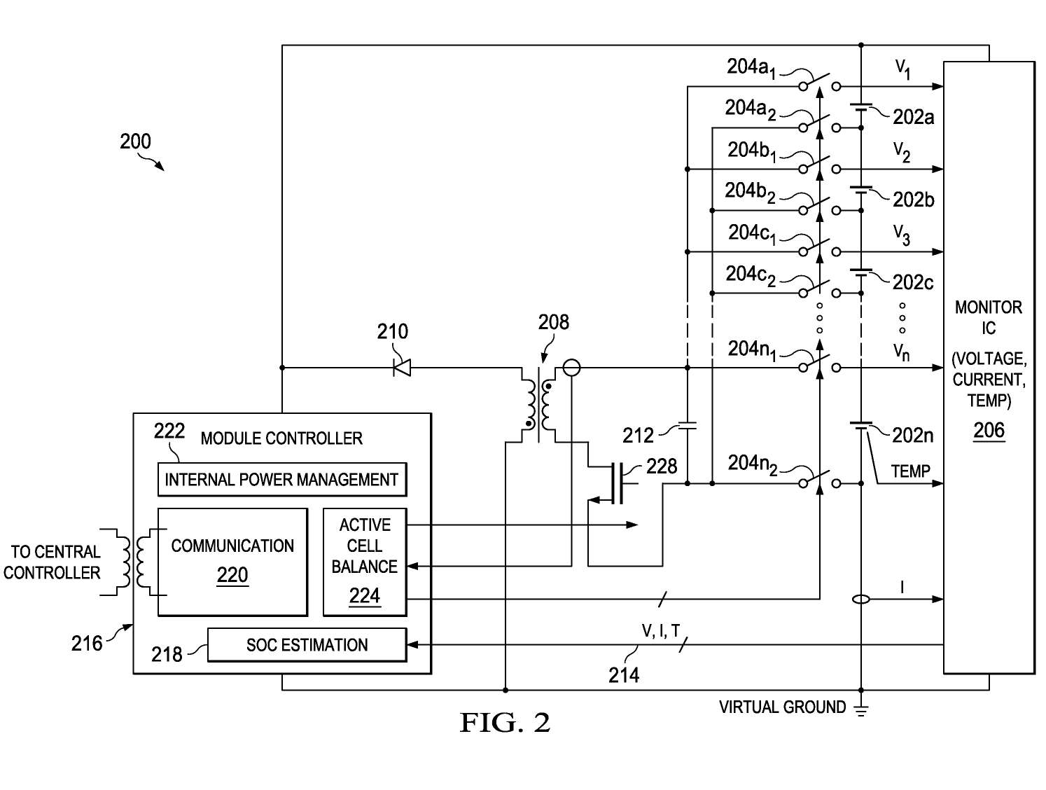

FIG. 2 illustrates another example active cell balancing circuit 200 in accordance with this disclosure. In this example, the circuit 200 employs flyback-based active cell balancing. The circuit 200 uses a flyback (boost type) converter to draw current from power cells that have undesirable higher voltages. The circuit 200 identifies a power cell that has more voltage and then causes that power cell to transfer a portion of its voltage back to the entire string of power cells.

As shown in FIG. 2, the circuit 200 includes power cells 202a-202n, which is coupled to two switches 204a1-204a2, 204b1-204b2, 204n1-204an2. The power cells 202a-202n are also coupled to a monitor circuit 206. The active cell balancing circuit 200 also includes a transformer 208, a diode 210, and a capacitor 212. The active cell balancing circuit 200 further includes a signal line 214 that provides voltage, current, and temperature information or other information from the monitor circuit 206 to a module controller 216. The module controller 216 includes an SOC estimation module 218, a communication module 220, an internal power management module 222, and an active cell balance module 224. A transistor 228 is coupled to the secondary side of the transformer 208. Many of these components may be structurally the same as or similar to corresponding components in FIG. 1. forward-based active cell balancing circuit 100. However, the flow of current is from the primary side of the transformer 208 through the diode 210 to the top of the power cell string (starting at the power ce11 202a). Also, the active cell balance module 224 receives a voltage signal from the secondary side of the transformer 208.

In one aspect of operation, the monitor circuit 206 may continually, near-continually, or intermittently monitor the power cells 202a-202n. The module controller 216 can determine which power cell has the highest voltage. The module controller 216 then causes that power cell to be discharged somewhat to a lower voltage. Pulse charging and discharging can be used to speed up the charging/discharging process in this example.

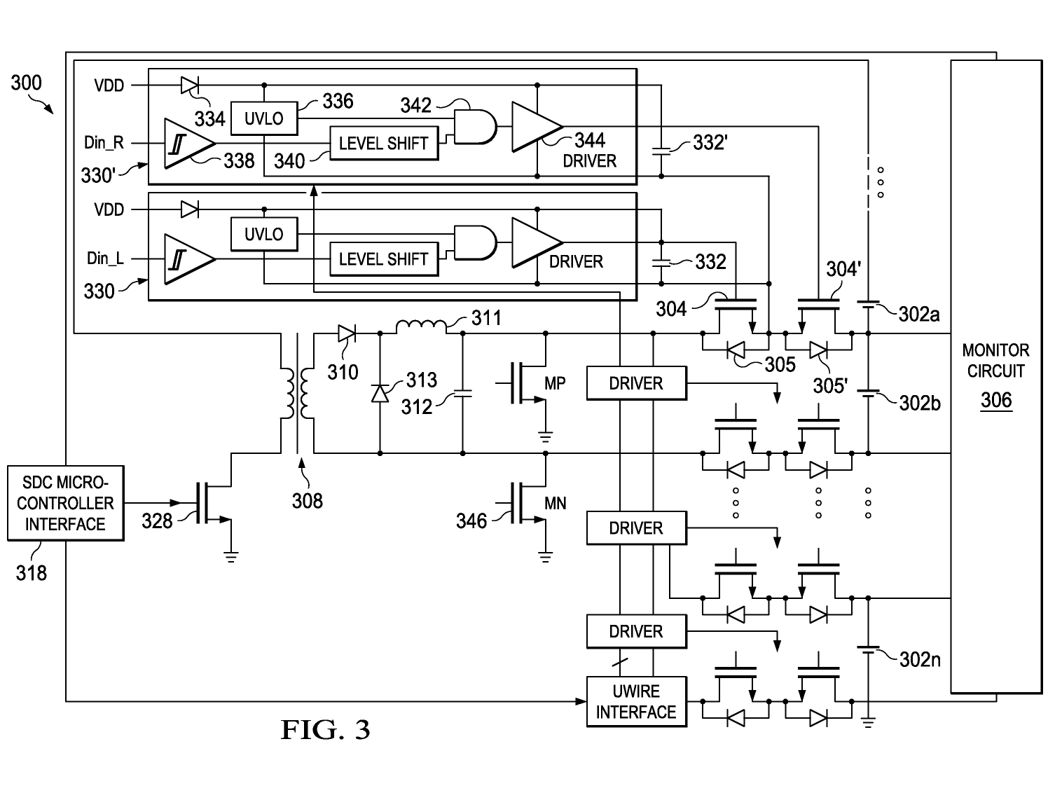

FIG. 3 illustrates an example active cell balancing circuit 300 incorporating switch driving circuits in accordance with this disclosure. In particular, the circuit 300 of FIG. 3 is similar in structure to the circuit 100 of FIG. 1. Note that the switch driving circuits could be used in other active balancing circuits, such as the circuit 200 of FIG. 2.

In this example, the circuit 300 includes power cells 302a-302n, a transformer 308, a diode 310, a capacitor 312, an SOC estimation module 318 with a micro-controller interface, and a transistor 328. In particular embodiments, the monitor circuit 306 could represent an LMP8631 analog front end from NATIONAL SEMICONDUCTOR CORPORATION. The circuit 300 also includes an inductor 311 coupled between the diode 310 and the capacitor 312, as well as a diode 313 coupled to the diode 310 and inductor 311 and to the capacitor 312.

Rather than using a single switch to couple one end of a power cell 302a-302n to the transformer 308, the circuit 300 uses a pair of switches to couple one end of a power cell to the transformer 308. For example, transistors 304 and 304′ can be used to couple one end of the power cell 302a to the transformer 308. Diodes 305 and 305′ represent the body diodes of the transistors 304 and 304′, respectively. Driver circuits 330 and 330′ drive the transistors 304 and 304′ and have boost capacitors 332 and 332′, respectively, which could represent off-chip capacitors.

In this example, each driver circuit 330 and 330′ includes a diode 334 that receives a supply voltage VDD. An under-voltage lockout (UVLO) unit 336 detects when the supply voltage VDD falls below a threshold level. A Schmitt trigger 338 receives an input drive signal (Din_R or Din_L) and generates an output signal for a level shifter 340, which shifts the voltage level of the output signal. An AND gate 342 receives outputs of the UVLO unit 336 and the level shifter 340 and provides an input to a driver 344. The driver 344 generates the drive signal for one of the transistors 304 and 304′. In particular embodiments, the driver circuits 330 and 330′ could represent LM5101A high-voltage high-side and low-side gate drivers from NATIONAL SEMICONDUCTOR CORPORATION.

In FIG. 3, each boost capacitor 332 or 332′ can have a charge path from its associated driver 334, through that boost capacitor, and through the body diode 305 or 305′ of its associated left transistor 304. Each left transistor 304 effectively has a floating current source on its left side. As a result, each boost capacitor 332 or 332′ can be charged since the floating current source node is periodically pulling to ground. Various driver circuits can also be disabled or enabled using a transistor 346 coupled to an input of that driver circuit.

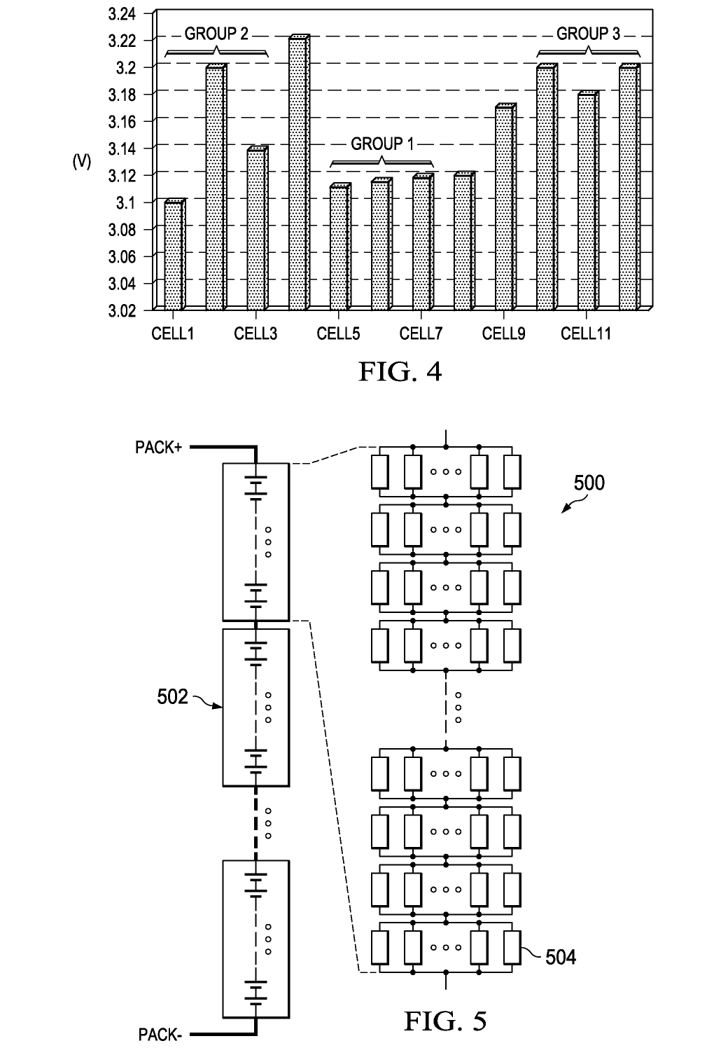

In some embodiments as described above, an active cell balancing circuit can charge or discharge individual power cells within a single module. It is also possible to charge or discharge groups of power cells within a single module. FIG. 4 illustrates an example algorithm that can be used during active cell balancing according to this disclosure.

In this example, an active cell balancing circuit may initially charge three cells coupled in series at a time, rather than charging just one cell at a time. For example, the active cell balancing circuit could charge cells 5-7 (Group 1) together for a certain time until cell 7 reaches the voltage of the maximum-voltage cell (cell 4 in this case). Then, cells 1-3 (Group 2) can be charged until cell 2 reaches the voltage of cell 4. After that, cells 10-12 (Group 3) can be charged until cell 10 reaches the voltage of cell 4. At this point, cells can be charged individually rather than three at a time.

As shown here, rather than simply charging one power cell at a time, multiple power cells (such as three cells) can be charged simultaneously. Once the groups of cells have been charged adequately, the algorithm can switch and begin charging cells individually. A similar algorithm could be used to discharge groups of cells together. This algorithm could allow for faster charging or discharging times. A combination of approaches could also be used, such as where groups of cells are charged to an average charge of the cells and groups of cells are discharged to the average charge of the cells before individual cells are charged/discharged.

Active cell balancing can be useful in a number of situations. As a particular example, active cell balancing (such as shown in FIGS. 1 through 3) can be useful in situations where some (but not all) cells in a module are being replaced. In that case, active cell balancing may be needed since there can be a large difference between the charge levels of the older cells and the charge levels of the newer cells. Without balancing, it may not be possible to charge the older and newer cells to a relatively equal level. This could significantly interfere with the operation of the module and may force replacement of all battery cells in the module, even battery cells that can still hold an adequate charge. Also, the group charging/discharging algorithm described with respect to FIG. 4 could be used to increase the speed at which the balancing of the older and newer cells occurs.

Active Module Balancing

In another aspect of this disclosure, various module balancing circuits are provided that can regulate multiple modules (such as multiple batteries), each of which may contain multiple battery cells or other power cells. In some embodiments, the multiple modules could form one or multiple packs, such as one or multiple battery packs.

FIG. 5 illustrates an example power pack 500 with multiple modules 502 each having multiple power cells 504 according to this disclosure. In this example, the modules 502 are coupled in series and provide an output voltage Pack+/Pack−. Also, groups of cells 504 are arranged in parallel, and parallel groups of cells 504 are coupled serially to form each module 502. Each module 502 could represent a battery formed by multiple battery cells.

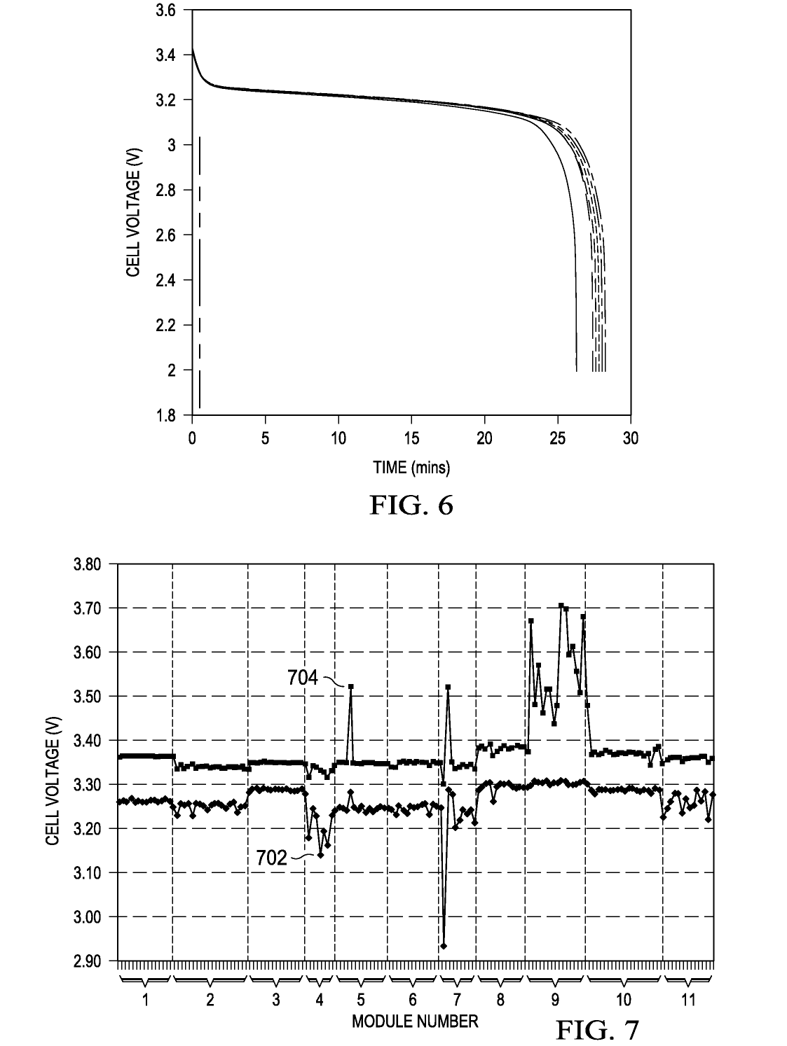

FIG. 6 illustrates example safe operating regions of various batteries according to this disclosure. As shown in FIG. 6, all of the cells 504 in each module 502 often must operate within a specified safe operating region under all charging and discharging conditions. In FIG. 6, the lines represent the safe operating regions for different batteries. In general, the safe operating regions for these batteries is between 2.0-3.5V.

FIG. 7 illustrates example uneven voltage levels on power cells in modules according to this disclosure. As shown in FIG. 7, mismatch issues can affect charging of the cells 504. In FIG. 7, a line 702 represents the charges on the cells 504 in various modules before charging, and a I ne 704 represents the charges on the cells 504 in various modules after charging. As can be seen here, mismatch issues can prevent many cells 504 from being charged and can possibly force some of the cells 504 to operate outside the 2.0-3.5V range. Any module balancing approach can take this safe operating region into account.

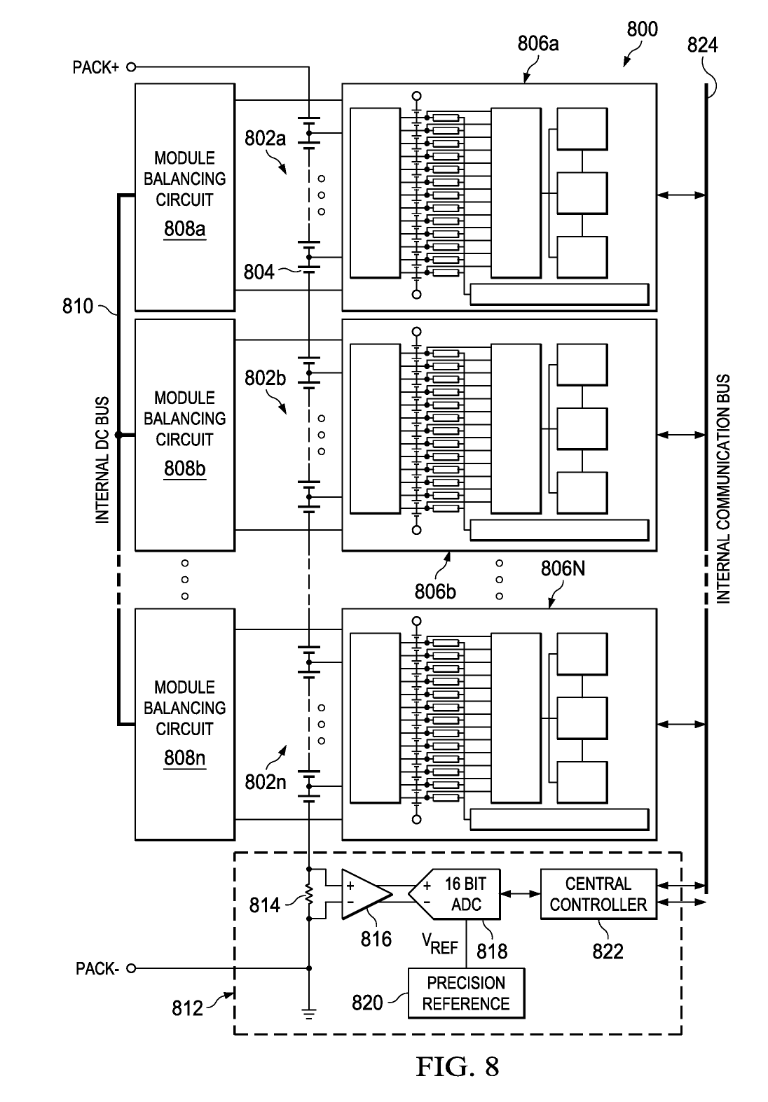

FIG. 8 illustrates an example active module balancing system BOO in accordance with this disclosure. In this example, the active module balancing system BOO includes multiple modules B02a-B02n, each of which includes multiple power cells B04 coupled in series. Each of the modules B02a-B02n has a corresponding module controller B06a-B06n, each of which includes an active cell balancing circuit used to perform active cell balancing within the corresponding module. Each module controller B06a-B06n could, for instance, include any of the active cell balancing circuits described above or below.

The active module balancing system 800 further includes multiple module balancing circuits 800a-8n. The module balancing circuits 800a-800n can control the power provided to or removed from the modules 802a-802n, which can help to control the charging or discharging of the modules 802a-802n. The module balancing circuits 808a-808n are coupled to an internal direct current (DC) bus B10, which is used to route DC power to and between the module balancing circuits 808a-808n.

A central control unit B12 monitors the current provided by the modules 802a-802n. The central control unit 812 here includes a resistor 814 through which the current provided by the modules 802a-802n flows. The central control unit 812 also includes a difference amplifier 816 that amplifies a voltage difference across the resistor 814. An analog-to-digital converter (ADC) 818 digitizes an output of the difference amplifier 814 using a reference voltage (VREF) provided by a precision reference 820. The ADC 818 could represent a 16-bit ADC, and the precision reference 820 could represent any suitable source of a reference voltage. A central controller 822 uses the digitized output of the ADC 818.

The central control unit 822 can also communicate with the module controllers 806a-806n over a bus 824. The central control unit 822 can further operate to control the balancing performed by the module balancing circuits 808a-808n and the module controllers 806a-806n.

In some embodiments, the central control unit 822 performs current sensing using the resistor 814. The central control unit 822 also performs state of charge or state of health (SOH) estimation for the modules 802a-802n and their cells 804. The central control unit 822 further performs module balance control to determine how to balance the modules 802a-802n and communicates the necessary data to the modules 802a-802n and the module controllers 806a-806n.

In particular embodiments, during module balancing, the internal DC bus 810 can be used for energy buffering and transfers between the modules 802a-802n. The module controllers 806a-806n and module balancing circuits 808a-808n can receive SOC information from the central control unit 812. The module with highest SOC can charge the module with lowest SOC directly through the internal DC bus 810. The module balancing circuits 808a-808n can operate in voltage mode when in a discharging status and in current mode when in a charging status (although other modes could be used when in the charging and discharging statuses, such as current mode when in the discharging status and in voltage mode when In the charging status).

Bi-Directional Active Balancing

In yet another aspect of this disclosure, various bi-directional active balancing circuits are disclosed that can balance multiple power cells in one or more modules. In these embodiments, it is possible for the active balancing circuits to transfer power from one or more power cells (such as a power cell with a higher charge) to one or more other power cells (such as a power cell with a lower charge). Note that the module balancing circuits described above already indicated that the power transfer on the internal DC bus 810 could be bi-directional, meaning the active module balancing system 800 can support bi-directional power transfer on the bus 810.

Referring back to FIG. 7, the cells represented by the lowest charges in the line 702 may represent cells that require charging (compared to other cells). Similarly, the cells represented by the highest charges in the line 704 may represent cells that require discharging (compared to other cells). Bi-directional active balancing would allow an individual cell to be charged or discharged, depending on its charge level relative to other cells. As shown in FIG. 7, bi-directional active balancing would allow the cells having excessive charge to be used to charge the cells having lower charge.

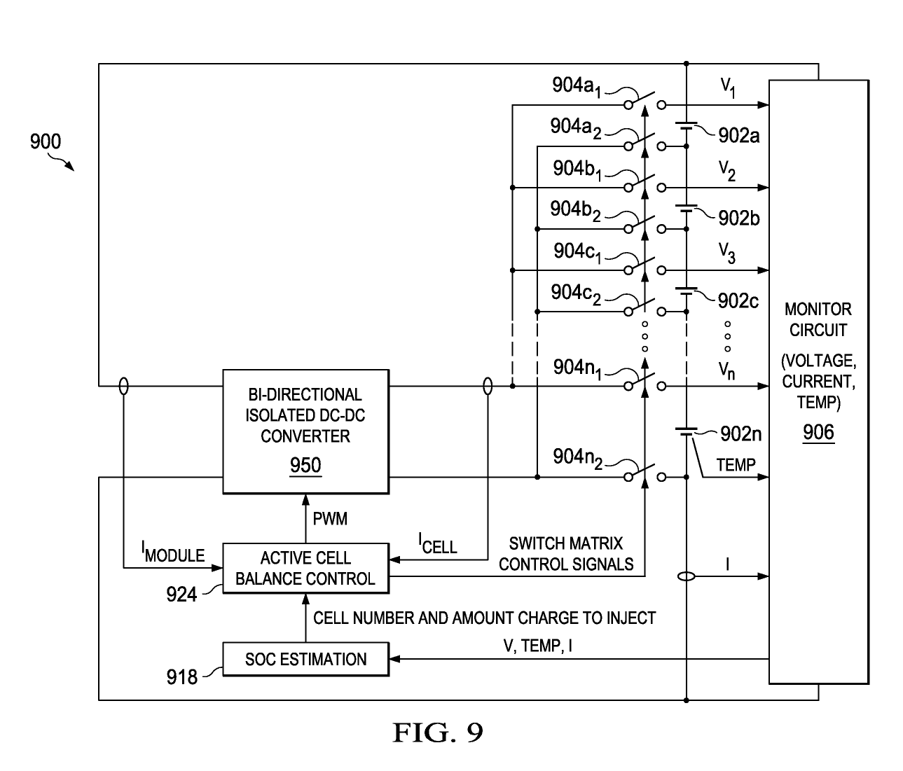

FIG. 9 illustrates an example bi-directional active cell balancing circuit 900 that supports active cell balancing within a module according to this disclosure. The active balancing circuit 900 includes multiple power cells 902a-902n and switches 904a1-904a2, 904b1-904b2, 904n1-904n2. The active balancing circuit 900 also includes a monitor circuit 906. Here, the output of the monitor circuit 906 is provided to an SOC estimation module 918, which can identify the power cells 902a-902n that need charging and discharging. An active cell balance control module 924 controls the switches 904a1-904n2 in order to charge or discharge the appropriate power cell(s) 902a-902n.

A bi-directional isolated DC-to-DC converter 950 is used to provide a balancing current to or from the power cells 902a-902n in order to support the active balancing. Current flowing into or out of the module (I w) and current flowing into or out of the cells 902a-902n (IcELL) can be measured and used by the active cell balance control module 924. If used in the active module balancing system 800, the DC-to-DC converter 950 could form part of the module balancing circuits 808a-808n and transfer power over the DC bus 810.

In some embodiments, voltage, temperature, and/or current sensing can be done for each cell 902a-902n to estimate its state of charge. Current or charge can be injected from the module into the cell(s) with the least SOC, and the cell(s) with the most SOC can be discharged back to the module. Balancing current (charge and discharge) injection can be performed in a way that is superimposed on the main module charging/discharging current (used to balance the modules). Balancing current (both directions) can be handled by the bi-directional DC-DC converter 950, and the switch matrix can handle which cell is charged or discharged.

Once again, as a particular example, active module balancing and bi-directional balancing can be useful in situations where some but not all power cells in a pack (formed from multiple modules) are being replaced. The active balancing may be needed since there can be a large difference between the charge levels of the older modules and the charge levels of the newer modules.

Although the figures have illustrated various embodiments for active balancing as described above, any number of changes can be made to these figures. For example, any number of power supplies in any number of modules could be balanced using these circuits. Also, note that other power supplies could be used in place of or in addition to battery cells in batteries, such as super-capacitors.

It may be advantageous to set forth definitions of certain words and phrases that have been used within this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like.

It may be advantageous to set forth definitions of certain words and phrases that have been used within this patent document. The term “couple” and its derivatives refer to any direct or indirect communication between two or more components, whether or not those components are in physical contact with one another. The terms “include” and “comprise,” as well as derivatives thereof, mean inclusion without limitation. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like.

While this disclosure has described certain embodiments and generally associated methods, alterations and permutations of these embodiments and methods will be apparent to those skilled in the art. Accordingly, the above description of example embodiments does not define or constrain this invention. Other changes, substitutions, and alterations are also possible without departing from the spirit and scope of this invention as defined by the following claims.

What is claimed is:

1. A system comprising:
a power module of multiple power cells coupled in series, the power cells exhibiting different charge levels during charging and discharging;
charging circuitry configured to supply charging current to the power cells;
an active cell balancing circuit configured to substantially balance the charges of the power cells at least during charging, including:
current source circuitry configured to supply extra charging current to a selected power cell;
current source control circuitry configured to control the current source circuitry to supply extra charging current to the power cell with the lowest state of charge.

2. The system of claim 1, further comprising:
multiple power modules, each power module including multiple power cells coupled in series, each power module having a charge that is based on charges of the power cells in that power module;
multiple active cell balancing circuits, each active cell balancing circuit configured to substantially balance the charges of the power cells in an associated one of the power modules at least during charging; and
an active module balancing system configured to substantially balance the charges of the power modules by at least one of: charging a first subset of the power modules and discharging a second subset of the power modules, wherein the active module balancing system comprises:
multiple module balancing circuits, each module balancing circuit associated with one of the power modules and configured to charge or discharge its associated power module; and
a direct current (DC) bus coupling the module balancing circuits, the DC bus configured to transport DC power between the module balancing circuits.

3. The system of claim 2, wherein:
each module balancing circuit is configured to operate in a voltage mode when discharging its associated power module; and
each module balancing circuit is configured to operate in a current mode when charging its associated power module.

4. The system of claim 2, wherein the system comprises multiple bi-directional isolated direct current-to-direct current (DC-DC) converters, each DC-DC converter associated with one of the power modules and configured to generate balancing currents for charging and discharging the power cells in its associated power module.

5. The system of claim 5, wherein each DC-DC converter is configured to superimpose the balancing current for its associated power module onto a power module charging or discharging current for its associated power module.

6. The system of claim 1, wherein each of the active cell balancing circuits comprises one of: a forward-based active cell balancing circuit and a flyback-based active cell balancing circuit.

7. The system of claim 1, wherein the current source circuitry comprises:
a transformer; and
a switch matrix comprising multiple switches, the multiple switches configured to selectively couple and uncouple the power cells in that power module to the transformer in order to control charging and discharging of the power cells in that power module;
the current source control circuitry configured to control the switch matrix in order to supply the extra charge current.

8. The system of claim 1,
wherein the active cell balancing circuit further comprises a monitor circuit configured to monitor state of charge information related to the power cells, and provide a corresponding state of charge indication for each of the respective power cells; and
wherein the current source control circuitry is configured to control the current source circuitry to supply extra charging current to the power cell with the lowest state of charge based on the respective state of charge indications for the power cells.

9. The system of claim 1, wherein the power modules comprise batteries and the power cells comprise battery cells.

10. The system of claim 1,
wherein the active cell balancing circuit is configured to substantially balance the charges of the power cells during charging and discharging of the power cells; and wherein the current source control circuitry is configured to control the current source circuitry to supply extra charging current to the power cell with the lowest state of charge during charging and discharging of the power cells.

11. An apparatus operable to provide active cell balancing for a power module of power cells coupled in series, the power cells exhibiting different charge levels during charging, comprising:
charging circuitry configured to supply charging current to the power cells;
an active cell balancing circuit configured to substantially balance the charges of the power cells at least during charging, including:
current source circuitry configured to supply extra charging current to a selected power cell;
current source control circuitry configured to control the current source circuitry to supply extra charging current to the power cell with the lowest state of charge.

12. The apparatus of claim 11, further comprising:
multiple active cell balancing circuits configured to be coupled to multiple power modules each of which comprises multiple power cells coupled in series, each active cell balancing circuit configured to substantially balance charges of the power cells in an associated one of the power modules;
multiple module balancing circuits configured to substantially balance charges of respective power modules by at least one of: charging a first subset of the power modules and discharging a second subset of the power modules;
a direct current (DC) bus coupling the module balancing circuits, the DC bus configured to transport DC power between the module balancing circuits; and
at least one module balancing controller configured to control the module balancing circuits;
each module balancing circuit is configured to operate in a voltage mode when discharging its associated power module; and
each module balancing circuit is configured to operate in a current mode when charging its associated power module.

13. The apparatus of claim 12, wherein the apparatus comprises multiple bi-directional isolated direct current-to-direct current (DC-DC) converters, each DC-DC converter associated with one of the power modules and configured to generate balancing currents for charging and discharging the power cells in its associated power module.

14. The apparatus of claim 13, wherein each DC-DC converter is configured to superimpose the balancing current for its associated power module onto a power module charging or discharging current for its associated power module.

15. The apparatus of claim 11, wherein the current source circuitry comprises:
a transformer; and
a switch matrix comprising multiple switches, the multiple switches configured to selectively couple and uncouple the power cells in that power module to the transformer in order to control charging and discharging of the power cells in that power module
the current source control circuitry configured to control the switch matrix in order to supply the extra charge current.

16. The apparatus of claim 11,
wherein the active cell balancing circuit further comprises a monitor circuit configured to monitor state of charge information related to the power cells, and provide a corresponding state of charge indication for each of the respective power cells; and
wherein the current source control circuitry is configured to control the current source circuitry to supply extra charging current to the power cell with the lowest state of charge based on the respective state of charge indications for the power cells.

17. The apparatus of claim 11,
wherein the active cell balancing circuit is configured to substantially balance the charges of the power cells during charging and discharging of the power cells; and wherein the current source control circuitry is configured to control the current source circuitry to supply extra charging current to the power cell with the lowest state of charge during charging and discharging of the power cells

18. A method employable with power cells coupled in series, the power cells exhibiting different charge levels during charging, comprising:
supplying charging current to charge the power cells;
generating state of charge information about each power cell;
supplying extra charging current, at least during charging, to the power cell with the lowest state of charge.

19. The method of claim 18, employable with a power module configuration in which each of multiple power modules include multiple power cells coupled in series, wherein a charge of each power module is based on the charges of the power cells in that power module, the method further comprising:
substantially balancing the charges of the power modules by at least one of: charging a first subset of the power modules and discharging a second subset of the power modules, wherein direct current (DC) power is transferred between the power modules using a DC bus
wherein substantially balancing the charges of the power cells in each power module and substantially balancing the charges of the power modules comprise:
using multiple bi-directional isolated direct current-to-direct current (DC-DC) converters, each DC-DC converter associated with one of the power modules and generating balancing currents to charge and discharge the power cells in its associated power module.

20. The method of claim 18, wherein generating state of charge information about each power cell is accomplished by monitoring state of charge information related to the power cells, and providing a corresponding state of charge indication for each of the respective power cells.

21. The method of claim 18, wherein supplying extra charging current comprises:
operating a switch matrix comprising multiple switches to selectively couple and uncouple the power cells to a transformer in order to supply the extra charging current to the power cell with the lowest state of charge.

22. The method of claim 18,
wherein supplying extra charging current comprises supplying, during charging and discharging of the power cells, extra charging current to the power cell with the lowest state of charge.
